(19) United States
(12) Patent Application Publication
(10) Pub. No.: US 2010/0216681 A1
(43) Pub. Date: Aug. 26, 2010

(54) CLEANING COMPOSITION AND CLEANING METHOD FOR LIQUID CRYSTALLINE POLYESTER PRODUCTION DEVICE USING THE SAME

(75) Inventors: Yusaku Kohinata, Tsukuba-shi (JP); Satoshi Okamoto, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/708,264

(22) Filed: Feb. 18, 2010

(30) Foreign Application Priority Data
Feb. 24, 2009 (JP) 2009-040306
Jul. 2, 2009 (JP) 2009-157529

(51) Int. Cl. C11D 3/26

(52) U.S. Cl. 510/188

(57) ABSTRACT

The present invention provides a cleaning composition used for cleaning a device for producing a liquid crystalline polyester, the composition comprising (A) glycols, (B) amines and (C) a compound selected from the group consisting of cyclic esters, amides and sulfoxides, wherein the content of the component (B) is 5 to 40% by weight and the content of the component (C) is 5 to 30% by weight, both being with respect to the total weight of the cleaning composition.

### BACKGROUND OF THE INVENTION

1. Field of the Invention

The present invention relates to a cleaning composition used for cleaning a device for producing a liquid crystalline polyester and a cleaning method using the cleaning composition.

2. Description of the Related Art

A liquid crystalline polyester is so excellent in heat resistance and solvent resistance as to be used for various kinds of electronic parts and industrial parts. A liquid crystalline polyester can be produced in such a manner that part of raw material monomers for production are converted into an ester forming derivative to melt-polymerize the raw material monomers containing this ester forming derivative. Typically, a liquid crystalline polyester can be produced as follows. Namely, a liquid crystalline polyester is produced in such a manner that hydroxyl groups of aromatic hydroxycarboxylic acid or hydroxyl groups of aromatic hydroxycarboxylic acid and aromatic diol among the raw material monomers are first acetylated by acetic anhydride to obtain an acylated product thereof, and then, the raw material monomers containing the acylated product are melt-polymerized in a production device (a condensation polymerization tank) (see, for example, Japanese Unexamined Patent Publication No. 2004-331829). The liquid crystalline polyester after being produced is discharged out of the condensation polymerization tank while kept so warm as to maintain a molten state thereof. On that occasion, part of the liquid crystalline polyester, which has not been discharged out up, occasionally adheres to an inner wall of the condensation polymerization tank and remains, when a liquid crystalline polyester is produced next time by using the same condensation polymerization tank with such a remaining liquid crystalline polyester, the remaining liquid crystalline polyester is mixed in as a foreign matter (impurity), so that a liquid crystalline polyester with desired quality may not be obtained occasionally.

If the next production of the liquid crystalline polyester is carried out using the same condensation polymerization tank, it is preferred to clean out the tank after discharging the liquid crystalline polyester out of the tank in order to avoid such a contamination. Since the liquid crystalline polyester itself is so excellent in solvent resistance that it is preferred to use a cleaning composition which is capable of decomposing the liquid crystalline polyester for the cleaning. For example, it is proposed to use a composition of glycols and amines (primary amines or secondary amines) for the cleaning (see, Japanese Unexamined Patent Publication No. 5-295392).

### SUMMARY OF THE INVENTION

Incidentally, in the production device for the liquid crystalline polyester, a dephlegmator is occasionally provided in the condensation polymerization tank for improving polymerization efficiency by distilling out by-produced acetic acid during melt polymerization and for refluxing the easily volatile raw material monomers. When the inventors of the present invention studied, it appeared that the cleaning composition disclosed in Japanese Unexamined Patent Publication No. 5-295392 allows the remaining liquid crystalline polyester on an inner wall of a condensation polymerization tank to be sufficiently removed, but yet does not allow droplets of the liquid crystalline polyester and part of the raw material monomers adhering to the dephlegmator (occasionally referred to as “adhesion to a dephlegmator” hereinafter) to be sufficiently removed occasionally in the case of cleaning a condensation polymerization tank provided with the dephlegmator. In the case where the amount of the adhesion to a dephlegmator is remarkably large, the production device needs to be disassembled to physically remove the adhesion, leading to a deterioration in productivity of the liquid crystalline polyester.

The present invention has been made in view of the above circumstances, and intended to provide a cleaning composition capable of effectively cleaning not merely the remaining liquid crystalline polyester on an inner wall of a condensation polymerization tank but also droplets of the liquid crystalline polyester or the raw material monomers adhering and remaining in the dephlegmator (i.e., adhesion to a dephlegmator) which takes a role of returning the unreacted acetic anhydride to the tank, and to provide a cleaning method using the composition.

The inventors of the present invention have completed the present invention as a result of earnest studies for solving the problems. Namely, the present invention provides a cleaning composition used for cleaning a device for producing a liquid crystalline polyester, the composition comprising the following component (A), component (B) and component (C):

(A) glycols;

(B) amines; and

(C) a compound selected from the group consisting of cyclic esters, amides and sulfoxides,

wherein the content of the component (B) is 5 to 40% by weight and the content of the component (C) is 5 to 30% by weight, both being with respect to the total weight of the cleaning composition. Also, the present invention provides a cleaning method for a device for producing a liquid crystalline polyester, the method comprising the steps of:

(1) discharging a liquid crystalline polyester after melt polymerization out of a device for producing the liquid crystalline polyester;

(2) preparing the cleaning composition described above;

(3) charging the cleaning composition into the production device after the discharging step; and

(4) cleaning the inside of the production device by refluxing the cleaning composition in the production device.

A cleaning composition of the present invention may effectively clean not merely the remaining liquid crystalline polyester on an inner wall of a condensation polymerization tank used for producing a liquid crystalline polyester but also droplets of the liquid crystalline polyester or the raw material monomers adhering and remaining in a dephlegmator, etc. (adhesion to a dephlegmator). Then, a use of the cleaning composition of the present invention allows the liquid crystalline polyester to be produced without remarkably deteriorating productivity by reason of no need of complicated processes such as disassembly of the production device, resulting in being extremely industrially useful.

### DETAILED DESCRIPTION OF THE INVENTION

A cleaning composition of the present invention comprises the following component (A), component (B) and component (C) (occasionally referred to as “components (A) to (C)” hereinafter):

(A) glycols;

(B) amines; and

(C) a compound selected from the group consisting of cyclic esters, amides and sulfoxides,

wherein the content of the component (B) is 5 to 40% by weight and the content of the component (C) is 5 to 30% by weight, both being with respect to the total weight of the cleaning composition.

In the cleaning of a condensation polymerization tank of a liquid crystalline polyester, the inventors of the present invention conceived that a dephlegmator provided in the condensation polymerization tank might be favorably cleaned if a cleaning composition was properly vaporized and refluxed in the condensation polymerization tank and the vaporized gaseous cleaning composition might sufficiently dissolve adhesion to the dephlegmator. Then, they have reached the present invention by finding out that the cleaning composition containing the components (A) to (C) by specific amounts is sufficient in removability of the remaining liquid crystalline polyester adhering to an inner wall of the condensation polymerization tank and the solubility of adhesion to the dephlegmator becomes favorable in the case where the cleaning composition becomes gaseous.

Hereinafter, each component in the cleaning composition, an example of the liquid crystalline polyester to be removed out using the cleaning composition, an example of a production device to be cleaned, and a cleaning method for the production device of the present invention are sequentially described.

### <Cleaning Composition>

Each component in the cleaning composition of the present invention is described by referring to specific examples.

Glycols as the component (A) are the compounds having two alcoholic hydroxyl groups in its molecule, and are compounds typically represented by the following formula (I):

HO—R¹—OH (I)

(wherein R¹ denotes an alkylene group with 2 to 30 carbon atoms, which is optionally discontinued by an oxygen atom.) Specific examples of the glycols include ethylene glycol, diethylene glycol, triethylene glycol, tetraethylene glycol and polyethylene glycol. Among these, in consideration of appropriate boiling point and low cost of the cleaning composition described later, glycols selected from the group consisting of diethylene glycol, triethylene glycol and tetraethylene glycol are preferable, and triethylene glycol is particularly preferable.

Amines as the component (B) are compounds having an amino group in its molecule, and the amino group may be a primary amino group or a secondary amino group, and the compounds may have a combination of a primary amino group and a secondary amino group in a molecule. Specific examples of the amines include amines having an alkyl group, such as diethylamine, propylamine, dipropylamine, butylamine, dibutylamine and hexylamine, diamines such as ethylenediamine, tetramethylenediamine and pentamethylenediamine, amines having an aromatic ring, such as aniline and benzylamine, and alkanolamines such as monoethanolamine, diethanolamine and triethanolamine. Among these, in consideration of an appropriate boiling point and low cost of the cleaning composition described later, alkanolamines, above all, monoethanolamine and/or diethanolamine are preferable, and monoethanolamine is particularly preferable in further consideration of handleability.

The component (C) is a compound selected from the group consisting of cyclic esters, amides and sulfoxides.

Cyclic esters are the compounds having an ester bond (—C(═O)—O—) in a ring and are also called lactones. Typical examples of the cyclic esters include compounds such that one of methylene groups composing a cycloalkane ring with 4 to 7 carbon atoms is substituted with an ester bond. In consideration of appropriate boiling point of the cleaning composition described later, γ-butyrolactone is appropriately selected from easily available compounds from the market.

Amides are the compounds having an amide bond in its molecule, and may be chain (acyclic) or cyclic (lactams). In consideration of an appropriate boiling point of the cleaning composition described later, amides selected from the group consisting of N,N-dimethylacetamide, N,N-dimethylformamide and N-methyl-2-pyrrolidone are appropriately selected from easily available compounds from the market.

Sulfoxides are the compounds having a sulfenyl group (—S(═O)—) in its molecule, and in consideration of an appropriate boiling point of the cleaning composition described later, dimethyl sulfoxide is appropriately selected from easily available compounds from the market.

In such cyclic esters, amides or sulfoxides, which are particularly favorable in cleanability of a dephlegmator, the dipole moment thereof is preferably 3 or more. A use of compounds with a too small dipole moment for the component (C) occasionally causes it to comparatively take time to remove adhesion to the dephlegmator. In consideration of such a dipole moment, N-methylpyrrolidone is particularly preferable as the component (C).

The cleaning composition of the present invention preferably has under one (1) atmosphere, the boiling point in a range from not lower than 190° C. to not higher than 240° C., more preferably has the boiling point in a range from not lower than 200° C. to not higher than 240° C., and further more preferably has the boiling point in a range from not lower than 210° C. to not higher than 240° C. In a cleaning method using the cleaning composition of the present invention, higher temperature in cleaning brings a greater effect of cleaning the remaining liquid crystalline polyester on an inner wall of a condensation polymerization tank by reason of increasing decomposability for the liquid crystalline polyester. Thus, the boiling point of the cleaning composition is preferably not lower than 190° C. On the other hand, the cleaning composition needs to be vaporized and refluxed for cleaning the dephlegmator as described above. A too high boiling point of the cleaning composition needs a high temperature in vaporizing and refluxing to bring a rise in energy cost. Thus, the boiling point of the cleaning composition is preferably not higher than 240° C. Specifically, from the viewpoint of removability (cleanability of the condensation polymerization tank) of the remaining liquid crystalline polyester on an inner wall of the condensation polymerization tank, the cleaning temperature is preferably not lower than 190° C., more preferably not lower than 200° C., and further more preferably not lower than 210° C. A too low cleaning temperature deteriorates cleanability of the condensation polymerization tank to take time to remove the remaining liquid crystalline polyester. From the viewpoint of productivity, the cleaning time is preferably shorter. Specifically, the cleaning time is 1 to 12 hours, and preferably 2 to 8 hours.

With regard to the total weight of the cleaning composition of the present invention, the component (B) is contained in a range from 5 to 40% by weight, preferably from 7 to 30% by weight. The content of the component (B) in less than this range brings a tendency to deteriorate removability of the remaining liquid crystalline polyester adhering to an inner wall of the condensation polymerization tank by reason of decreasing decomposability for the liquid crystalline polyester. On the other hand, the content of the component (B) in more than this range lowers the boiling point of the cleaning composition so easily as to bring a tendency to be lower than the appropriate boiling point in a remarkable case.

With respect to the total weight of the cleaning composition of the present invention, the component (C) is contained in a range of from 5 to 30% by weight, preferably from 8 to 20% by weight. The content of the component (C) in less than this range brings a tendency to decrease the effect of cleaning adhesion to the dephlegmator. On the other hand, the content of the component (C) more than this range lowers the boiling point of the cleaning composition so easily as to bring a tendency to be lower than the appropriate boiling point in the remarkable case. The inventors of the present invention have found out that a use of a compound with a high boiling point as the component (C) allows the boiling point of the cleaning composition to be kept comparatively high; however, in this case the component (C) is vaporized with such difficulty as not to contribute to the cleaning of adhesion to the dephlegmator.

The cleaning composition of the present invention contains the component (B) and the component (C) in each of the ranges, and the component (A), and the residue except the component (B) and the component (C) is preferably substantially the component (A). However, unintended impurities such as water are not prevented from slightly mixing into the cleaning composition of the present invention.

### <Liquid Crystalline Polyester>

Next, an example of a liquid crystalline polyester to be removed (i.e., cleaned out) with the cleaning composition of the present invention is briefly described. The liquid crystalline polyester is a polyester which forms a molten phase having optical anisotropy and exhibits liquid crystal characteristics, and examples thereof include fully aromatic polyester such that an aromatic ring is linked by an ester bond (—CO—O— or —O—CO—), fully aromatic poly(ester-amide) such that part of ester bonds of the fully aromatic polyester are substituted with an amide bond (—CO—NH— or —NH—CO—), or half aromatic polyester such that part of aromatic groups of the fully aromatic polyester are substituted with an alkylene group or an alkylidene group, such as —(CH₂)ₙ— (n denotes an integer of 1 or more). Among these, the fully aromatic polyester and the fully aromatic poly(ester-amide) have so excellent heat resistance and mechanical strength in the liquid crystalline polyester as to be in great demand from the market, but yet are so extremely excellent in solvent resistance that the cleaning of a production device therefor easily becomes comparatively difficult. Accordingly, the effect of the cleaning composition of the present invention may be further attained in the cleaning of a production device for such fully aromatic polyester and fully aromatic poly(ester-amide).

The liquid crystalline polyester is hereinafter described in detail by taking fully aromatic polyester that is an object to be cleaned with the cleaning composition of the present invention as an example. The liquid crystalline polyester is produced by polymerizing raw material monomers composed of aromatic hydroxycarboxylic acid, aromatic diol and aromatic dicarboxylic acid, for example.

Examples of the aromatic hydroxycarboxylic acid include para-hydroxybenzoic acid, meta-hydroxybenzoic acid, 2-hydroxy-6-naphthoic acid, 2-hydroxy-3-naphthoic acid, 1-hydroxy-4-naphthoic acid, 4-hydroxy-4′-carboxydiphenyl ether, 2,6-dichloro-para-hydroxybenzoic acid, 2-chloro-para-hydroxybenzoic acid, 2,6-difluoro-para-hydroxybenzoic acid and 4-hydroxy-4′-biphenylcarboxylic acid, and these may be used singly or in a combination of two kinds or more. Among these, solvent resistance of the obtained liquid crystalline polyester is comparatively favorable, and thus, examples of the aromatic hydroxycarboxylic acid easy in deteriorating the cleanability thereof include para-hydroxybenzoic acid and/or 2-hydroxy-6-naphthoic acid. The cleaning composition of the present invention is particularly effective for cleaning a production device (a condensation polymerization tank) for the liquid crystalline polyester obtained by using such aromatic hydroxycarboxylic acid as raw material monomers.

Examples of the aromatic diol include 4,4′-dihydroxybiphenyl, hydroquinone, resorcin, methyl hydroquinone, chlorohydroquinone, acetoxyhydroquinone, nitrohydroquinone, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis-(4-hydroxyphenyl)methane, bis-(4-hydroxy-3,5-dimethylphenyl)methane, bis-(4-hydroxy-3,5-dichlorophenyl)methane, bis-(4-hydroxy-3,5-dibromophenyl)methane, bis-(4-hydroxy-3-methylphenyl)methane, bis-(4-hydroxy-3-chlorophenyl)methane, 1,1-bis(4-hydroxyphenyl)cyclohexane, bis-(4-hydroxyphenyl)ketone, bis-(4-hydroxy-3,5-dimethylphenyl)ketone, bis-(4-hydroxy-3,5-dichlorophenyl)ketone, bis-(4-hydroxyphenyl)sulfide, and bis-(4-hydroxyphenyl) sulfone, and these may be used singly or in a combination of two kinds or more. Among these, solvent resistance of the obtained liquid crystalline polyester is comparatively favorable, and thus, examples of the aromatic diol easy in deteriorating the cleanability thereof include 4,4′-dihydroxybiphenyl. Also, examples of the aromatic diol easily adhering to the dephlegmator by reason of easily vaporizing include 4,4′-dihydroxybiphenyl and hydroquinone. The cleaning composition of the present invention is particularly effective for cleaning a production device (a condensation polymerization tank) for the liquid crystalline polyester obtained by using such aromatic diol as raw material monomers.

Examples of the aromatic dicarboxylic acid include terephthalic acid, isophthalic acid, 2,6-naphthalenedicarboxylic acid, 1,5-naphthalenedicarboxylic acid, 4,4′-biphenyldicarboxylic acid, methylterephthalic acid, methylisophthalic acid, diphenyl ether-4,4′-dicarboxylic acid, diphenyl sulfone-4,4′-dicarboxylic acid, diphenyl ketone-4,4′-dicarboxylic acid, and 2,2′-diphenyl propane-4,4′-dicarboxylic acid, and thus, these may be used singly or in a combination of two kinds or more. Among these, solvent resistance of the obtained liquid crystalline polyester is comparatively favorable, so that examples of the aromatic dicarboxylic acid easy in deteriorating the cleanability thereof include terephthalic acid and 2,6-naphthalenedicarboxylic acid. Also, examples of the aromatic dicarboxylic acid easily adhering to the dephlegmator by reason of easily vaporizing include terephthalic acid, isophthalic acid and 2,6-naphthalenedicarboxylic acid. The cleaning composition of the present invention is particularly effective for cleaning a production device (a condensation polymerization tank) for the liquid crystalline polyester obtained by using such aromatic dicarboxylic acid.

The amounts (ratios) of aromatic hydroxycarboxylic acid, aromatic dicarboxylic acid and aromatic diol to be used for producing the liquid crystalline polyester can be appropriately determined such that the liquid crystalline polyester obtained from them may develop liquid crystallinity. When the total amount of the aromatic hydroxycarboxylic acid, the aromatic dicarboxylic acid and the aromatic diol is assumed to be 100% by mol, the amounts of the aromatic hydroxycarboxylic acid, the aromatic dicarboxylic acid and the aromatic diol may be in the range of from 30 to 80% by mol, in the range of from 10 to 35% by mol and in the range of from 10 to 35% by mol, respectively.

### <Melt Polymerization Method and Production Device for Liquid Crystalline Polyester>

Next, an example of the production method of the liquid crystalline polyester is described in each step. Examples of a condensation polymerization tank of a production device for the liquid crystalline polyester include a mixing vessel type (longitudinal type) reactor, a wetted-wall column type reactor or a lateral type reactor. Such a condensation polymerization tank is provided with a proper mixing means. In the case of using a longitudinal type mixing vessel as the condensation polymerization tank, a mixing means provided with a mixing blade such as a multistage paddle blade, a turbine blade, a double helicam blade, an anchor type blade and a comb type blade is appropriate.

### Acylation Step:

In production of the liquid crystalline polyester which can be cleaned out with a cleaning composition of the present invention, an acylated product may be used as an ester-forming derivative. The acylated product can be obtained in such a method that a compound having hydroxy groups (such as an aromatic hydroxycarboxylic acid and an aromatic diol) is reacted with an acetic anhydride to convert the hydroxyl groups of the compound into acyloxyl groups (acylation reaction). The acylation disclosed in Japanese Unexamined Patent Publication No. 2004-256673 is appropriate for such an acylation reaction because of easiness of operation.

It is described in the Publication that aromatic hydroxycarboxylic acid, aromatic diol and aromatic dicarboxylic acid are previously mixed to obtain a mixture, into which acetic anhydride is mixed and acylated. Then, the acylation step is performed under a nitrogen atmosphere at a temperature of 130 to 180° C., thereby acylating hydroxyl groups in the aromatic hydroxycarboxylic acid and the aromatic diol to become corresponding acylated products (aromatic hydroxycarboxylic acid acylated product and aromatic diol acylated product), respectively. The use ratio of the aromatic hydroxycarboxylic acid, the aromatic diol and the aromatic dicarboxylic acid is adjusted in accordance with intended characteristics of the obtained liquid crystalline polyester, and the molar ratio of hydroxyl groups to carboxyl groups in the mixture of these raw material monomers is preferably 0.9 to 1.1.

The amount of acetic anhydride to be used may be 0.95 to 1.2 mol times, preferably 1 to 1.18 mol times, with respect to the total molar amount of hydroxyl groups of the aromatic hydroxycarboxylic acid and the aromatic diol. The period of time for the reaction of the acylation can be adjusted by kinds and amounts of the aromatic hydroxycarboxylic acid and the aromatic diol to be used, and a range of 15 minutes to 3 hours is preferable in consideration of the efficiency of industrial production.

In the stage of this acylation, the aromatic dicarboxylic acid may coexist in the reaction system. The reason therefor is that the aromatic dicarboxylic acid is not influenced at all by acetic anhydride and thereby does not have a bad influence at all on the acylation reaction.

### Melt-Polymerization Step:

A melt-polymerization step may be conducted subsequent to the acylation step. The melt-polymerization is a step of producing a liquid crystalline polyester by ester exchange of polymerizing acyloxyl groups in the acylated product with carboxyl groups in the acylated product of the aromatic hydroxycarboxylic acid and in the aromatic dicarboxylic acid to conduct polymerization. The melt-polymerization step can be performed in the condensation polymerization tank provided with the dephlegmator for distilling out by-produced acetic acid as described above. This condensation polymerization tank may be provided with a proper mixing means as described above.

The melt polymerization is preferably performed while heated up in a range from 130 to 400° C. at a rate of 0.1 to 50° C./minute, more preferably performed while heated up in a range from 150 to 350° C. at a rate of 0.3 to 5° C./minute.

This melt polymerization may be also performed in the presence of a proper catalyst. Known catalysts used for producing polyester may be used as this catalyst, and the inventors of the present invention have found out that a heterocyclic organic basic compound containing two or more of nitrogen atoms is appropriate as the catalyst in view of sufficiently preventing the obtained liquid crystalline polyester from coloring. A use of such a heterocyclic organic basic compound causes the polymerization reaction to easily proceed more smoothly, and may sufficiently prevent the obtained liquid crystalline polyester from coloring.

Examples of the heterocyclic organic basic compound containing two or more of nitrogen atoms include an imidazole compound, a triazole compound, a dipyridylyl compound, a phenanthroline compound and a diazaphenanthrene compound. Among these, an imidazole compound is preferably used from the viewpoint of reactivity, and 1-methylimidazole and/or 1-ethylimidazole are more preferably used in view of easy availability. The heterocyclic organic basic compound may be charged together with the raw material monomers before the acylation step, charged after the acylation step and before the melt-polymerization step, or charged together with the raw material monomers before the acylation step and further added after the acylation step and before the melt-polymerization step.

The liquid crystalline polyester after the melt polymerization tends to be excellent in mechanical strength and heat resistance when flowage starting temperature thereof is not lower than 200° C. and not higher than 280° C., and solid-phase polymerization typically used in the field allows the liquid crystalline polyester to have a high molecular weight and also allows the liquid crystalline polyester with greater heat resistance to be obtained. The flowage starting temperature herein means a temperature at which a melt viscosity denotes 4800 Pa.s (48000 poise) when the liquid crystalline polyester is extruded from a nozzle under a load of 9.8 MPa (100 kg/cm²) at a rate of temperature rise of 4° C./minute by using a capillary rheometer mounted with a dice having an inside diameter of 1 mm and a length of 10 mm, and the flowage starting temperature is an index for denoting the molecular weight of the liquid crystalline polyester known in the technical field (refer to “Liquid crystalline polymer-synthesis, molding, application-”, edited by Naoyuki KOIDE, pp 95 to 105, CMC Publishing Co., Ltd., published on Jun. 5, 1987).

### <Cleaning Method>

A cleaning method using the cleaning composition of the present invention comprises the following steps:

(1) discharging a liquid crystalline polyester after melt polymerization out of a device (condensation polymerization tank) for producing the liquid crystalline polyester;

(2) preparing a cleaning composition of the present invention;

(3) charging the cleaning composition into the production device (condensation polymerization tank) after the discharging step; and

(4) cleaning the inside of the production device by refluxing the cleaning composition in the production device.

The discharging step (1) is a step of discharging the liquid crystalline polyester after melt-polymerization out of the condensation polymerization tank while keeping so warm as to retain a molten state thereof. In this discharging step, an appropriate heating means may be provided in a discharge opening for easily retaining a molten state of the liquid crystalline polyester, and the inside of the condensation polymerization tank may be pressurized by nitrogen gas for shortening time to discharge the polyester. However, in this manner, even though an appropriate heating means is provided and the pressurization is performed in discharging the liquid crystalline polyester, part of the liquid crystalline polyester remains on an inner wall of the condensation polymerization tank, and droplets of the liquid crystalline polyester and the raw material monomers adhering to a dephlegmator may not be removed. Accordingly, the cleaning using the cleaning composition of the present invention is extremely effective.

The preparing step (2) is a step of preparing the cleaning composition of the present invention by mixing the components (A) to (C). The cleaning composition may be prepared in such a manner that the component (A), the component (B) and the component (C) are charged into the condensation polymerization tank after discharging the liquid crystalline polyester, and stirred in the condensation polymerization tank, but it is preferable that a preparing tank is previously prepared except for the condensation polymerization tank to charge the components (A) to (C) into the preparing tank and obtain the cleaning composition. The cleaning composition of the present invention may be obtained in such a manner that the components (A) to (C) are mixed and stirred at a preparation temperature of −10 to 50° C. A comparatively short time such as approximately 10 minutes is enough for a stirring time, and the stirring time may be properly adjusted by the capacity of the preparing tank.

The cleaning composition obtained in the preparing step (2) is fed from the preparing tank to the condensation polymerization tank after discharging the liquid crystalline polyester [the charging step (3)]. The feeding step is not particularly limited. For example, the preparing tank and the condensation polymerization tank are connected by a proper feeding pipe, and the cleaning composition in the preparing tank may be fed to the condensation polymerization tank by this feeding pipe. The amount (fed amount) of the cleaning composition charged into the condensation polymerization tank may be in a range from 50 to 80% by volume when the internal volume of this condensation polymerization tank assumed to be 100% by volume. In charging the cleaning composition into the condensation polymerization tank, the temperature of the heating means of the condensation polymerization tank is preferably adjusted so that the temperature of the charged cleaning composition is in a range from 0 to 80° C.

Next, the inside of the condensation polymerization tank is cleaned by heating the cleaning composition until the cleaning composition charged into the condensation polymerization tank is vaporized and refluxed [the cleaning step (4)]. The heating conditions at this time may be adjusted by the boiling point of the used cleaning composition. With regard to the reflux, in the case where the condensation polymerization tank is provided with a dephlegmator, the coolant temperature of the dephlegmator is adjusted so that vapor of the cleaning composition (the gaseous cleaning composition) can be sufficiently liquefied by the dephlegmator.

The cleaning time in the cleaning step may be 1 to 12 times, preferably 2 to 8 times. The cleaning time referred herein means the time from a time point of start of heating the cleaning composition to a time point of discharging the cleaning composition out of the condensation polymerization tank.

Subsequently, the cleaning composition in the condensation polymerization tank is discharged out of the condensation polymerization tank. The raw material monomers, the liquid crystalline polyester and decomposed products of the liquid crystalline polyester are typically dissolved or dispersed in the cleaning composition after the cleaning step, so that such a cleaning composition is preferably cooled sufficiently when discharged out of the condensation polymerization tank. After cooling until the temperature of the cleaning composition is not higher than 80° C., the cleaning composition after being cleaned is appropriately discharged out of the condensation polymerization tank.

After discharging the cleaning composition, the inside of the condensation polymerization tank may be directly dried by heating operation and/or ventilating operation, but the inside of the condensation polymerization tank is preferably washed in water sufficiently for sufficiently removing the cleaning composition remaining in the condensation polymerization tank, and such washing in water is preferably performed by a method such that water is charged into the condensation polymerization tank after discharging the cleaning composition to vaporize and reflux this water. Then, after the condensation polymerization tank is sufficiently cooled until vaporization and reflux of the water therein stop, the water is discharged out of the condensation polymerization tank. Such washing in water through a series of operations may be performed a plurality of times. The inside of the condensation polymerization tank after being washed in water is preferably dried sufficiently by the operations as described above.

The remaining liquid crystalline polyester adhering to an inner wall of the condensation polymerization tank and adhesion to the dephlegmator are sufficiently removed by performing the above-mentioned step (1) to (4) and preferably washing in water. When the liquid crystalline polyester is produced next time by using the condensation polymerization tank cleaned in this manner, impurities mixing resulting from the remaining liquid crystalline polyester may be sufficiently avoided to allow the liquid crystalline polyester of desired quality to be obtained, and additionally, a complicated step of disassembling and cleaning the dephlegmator is unnecessary; thus, an excellent effect of not remarkably deteriorating productivity of the liquid crystalline polyester is exhibited.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by following Examples, which should not be construed as a limitation upon the scope of the present invention.

### Synthesis Example 1

### Production of Liquid Crystalline Polyester

A para-hydroxybenzoic acid (995 g (7.2 mol)), a 4,4′-dihydroxybiphenyl (447 g (2.4 mol)), a terephthalic acid (299 g (1.8 mol)), a isophthalic acid (99.6 g (0.60 mol)) and an acetic anhydride (1348 g (13.2 mol)) were charged into a reaction vessel (condensation polymerization tank) provided with a stirrer, a torquemeter, a nitrogen gas introduction pipe, a thermometer and a reflux cooler (dephlegmator), and these components were stirred. Next, 0.18 g of 1-methylimidazole was added to the mixture after being stirred, and the inside of the reaction vessel was sufficiently replaced with nitrogen gas, thereafter heated to a temperature of 150° C. over 15 minutes under nitrogen gas airflow and refluxed for 1 hour while retaining the temperature. Then, after adding 1.8 g of 1-methylimidazole, the inside thereof was heated to a temperature of 305° C. over 2 hours and 50 minutes while distilling off by-produced distillate acetic acid and unreacted acetic anhydride. The time point when the rise of torque was observed was regarded as the completion of the reaction, and the contents were taken out into a vat in a molten state and cooled. The liquid crystalline polyester cooled to approximately room temperature was ground with a vertical grinder (Orient VM-16 manufactured by Seishin Enterprise Co., Ltd.) until an average particle diameter thereof became approximately 300 to 500 μm to obtain liquid crystalline polyester particles. When the flowage starting temperature of the ground particles after being ground was measured and it was found to be 253° C., and the particles showed a molten state exhibiting optical anisotropy at a temperature of not lower than 280° C. The reflux cooler was detached from the used reaction vessel to recover droplets of the liquid crystalline polyester and the raw material monomers adhering to the reflux cooler (adhesion to the dephlegmator). The same synthesis was performed several times to recover the liquid crystalline polyester particles and the adhesion to the dephlegmator by predetermined amounts. The flowage starting temperature was measured in the following manner.

### Measuring Method of Flowage Starting Temperature:

Approximately 2 g of the liquid crystalline polyester was filled into a capillary rheometer mounted with a dice having an inside diameter of 1 mm and a length of 10 mm by using a flow tester (CFT-500 type, manufactured by Shimadzu Corporation). Then, a temperature at which melt viscosity denotes 4800 Pa.s (48000 poise) was measured while extruding the liquid crystalline polyester from a nozzle under a load of 9.8 MPa (100 kg/cm²) at a rate of temperature rise of 4° C./minute, and this temperature was regarded as a flowage starting temperature.

### Example 1

### Solubility Test of Liquid Crystalline Polyester

A 500-ml cylindrical separable flask was mounted with an anchor-type stirring blade manufactured by SUS, a cooling pipe, a thermometer and a nitrogen introduction pipe, and the separable flask was set in a mantle heater and assumed to be a test device A. 256.3 g of triethylene glycol (hereinafter referred to as “TEG”), 46.6 g of monoethanolamine (hereinafter referred to as “META”) and 30.8 g of N-methyl-2-pyrrolidone (hereinafter referred to as “NMP”) were mixed to prepare a cleaning composition 1 (the composition of the cleaning composition 1 is shown in Table 1). With regard to the dipole moments of these compounds, document data described in Solvent Handbook (Kodansha Ltd., Publishers, 1996, the 14th issue) were TEG (dipole moment: 5.58), META (dipole moment: 2.27) and NMP (dipole moment: 4.09).

The total amount of the cleaning composition 1 thus prepared and 50 g of the liquid crystalline polyester powder obtained in Synthesis Example 1 were charged into the test device A, heated to a temperature of 221° C. under a nitrogen atmosphere, and kept warm at the same temperature for 2 hours. The contents were stirred at a stirring rate of 150 rpm during keeping warm. After keeping warm, the internal temperature was cooled to a temperature of 80° C., and the insolubles against the used cleaning composition were filtered through an 80-mesh stainless-steel wire net (aperture: 0.18 mm). In addition, this wire net was washed in a large amount of methanol. After washing, when this wire net was sufficiently dried and the weight of the insolubles remaining on the wire net was measured, the remaining of the insolubles was not confirmed (the amount of the insolubles: approximately 0 g). This result shows that the liquid crystalline polyester or decomposed products thereof were sufficiently dissolved in the cleaning composition 1 and that cleanability of the cleaning composition 1 for the remaining liquid crystalline polyester is favorable.

### <Solubility Test of Adhesion to Dephlegmator>

First, when the cleaning composition 1 prepared in the same manner as the above description was vaporized and refluxed, the composition of the gaseous cleaning composition 1 through vaporization (vapor-phase cleaning composition 1) was measured in the following manner. The cleaning composition 1 was put in a simple distillation apparatus to perform simple distillation of the cleaning composition 1. Then, the composition of a fraction distilled out by the simple distillation was measured by gas chromatography (GC) on the following conditions and found to be 3% by weight of TEG, 76% by weight of META and 21% by weight of NMP.

### <GC Analysis Conditions>

GC apparatus: manufactured by Agilent Technologies gas chromatograph 6890N type

Analysis column: Rtx-5-Amine manufactured by Restek (0.25 mm ID, 30 m, 0.50 μm df)
Carrier gas: helium
Flow rate: 1 ml/minute (constant flow mode)
Sample injection amount: 1 μl (solution concentration 5 mg/ml)
Inlet temperature: 300° C.
Split ratio: 50:1
Heating conditions: initial temperature 50° C. (retained for 1 minute)
heating rate 20° C./minute
final temperature 310° C. (retained for 4 minutes)

### Detection: FID (315° C.)

Through the composition of the vapor-phase cleaning composition 1 measured in this manner, 10.1 g of TEG, 252.9 g of META and 64.7 g of NMP were mixed to prepare a model solution 1 of the vapor-phase cleaning composition 1. Subsequently, the total amount of the model solution 1 and 15 g of the adhesion to the dephlegmator obtained in Synthesis Example 1 were charged into the test device A, heated to a temperature of 131° C. under a nitrogen atmosphere, and kept warm at the same temperature for 2 hours. The contents were stirred at a stirring rate of 50 rpm during keeping warm. After keeping warm, the internal temperature was cooled to a temperature of 80° C., and the insolubles against the used cleaning composition were filtered through an 80-mesh stainless-steel wire net (aperture: 0.18 mm). In addition, the wire net was washed in a large amount of methanol. After washing, when this wire net was sufficiently dried and the weight of the insolubles remaining on the wire net was measured, the remaining of the insolubles was not confirmed (the amount of the insolubles: approximately 0 g). This result shows that the adhesion to the dephlegmator was sufficiently dissolved in the model solution 1 and that the vapor-phase cleaning composition 1 through vaporization of the cleaning composition 1 is effective for cleaning the adhesion to the dephlegmator.

### Example 2

### Solubility Test of Liquid Crystalline Polyester

The solubility test of the liquid crystalline polyester was carried out by performing the same experiment as Example 1 except for replacing the cleaning composition 1 with a cleaning composition 2 prepared from 239.4 g of TEG, 46.6 g of META and 46.2 g of NMP (the composition of the cleaning composition 2 is shown in Table 1). As a result, the amount of the insolubles remaining on the wire net was approximately 0 g. This result shows that the liquid crystalline polyester or decomposed products thereof were sufficiently dissolved in the cleaning composition 2 and that cleanability of the cleaning composition 2 for the remaining liquid crystalline polyester is favorable.

### <Solubility Test of Adhesion to Dephlegmator>

The composition of a gaseous cleaning composition 2 was examined by performing a simple distillation experiment of the cleaning composition 2 in the same manner as Example 1. The result was 2% by weight of TEG, 72% by weight of META and 26% by weight of NMP. Through this composition, 6.7 g of TEG, 239.5 g of META and 80.1 g of NMP were mixed to prepare a model solution 2, and then the same solubility test of the adhesion to the dephlegmator as Example 1 was performed except for using the total amount of this model solution 2 and 15 g of the adhesion to the dephlegmator obtained in Synthesis Example 1 and determining the temperature during keeping warm at 214° C. This result shows that the adhesion to the dephlegmator was sufficiently dissolved in the model solution 2 and that the vapor-phase cleaning composition 2 through vaporization of the cleaning composition 2 is effective for cleaning the adhesion to the dephlegmator.

### Example 3

### Solubility Test of Liquid Crystalline Polyester>

The solubility test of the liquid crystalline polyester was carried out by performing the same experiment as Example 1 except for replacing the cleaning composition 1 with a cleaning composition 3 prepared from 202.3 g of TEG, 239.5 g of META and 80.1 g of NMP (the composition of the cleaning composition 3 is shown in Table 1). As a result, the amount of the insolubles remaining on the wire net was approximately 0 g. This result shows that the liquid crystalline polyester or decomposed products thereof were sufficiently dissolved in the cleaning composition 3 and that cleanability of the cleaning composition 3 for the remaining liquid crystalline polyester is favorable.

### <Solubility Test of Adhesion to Dephlegmator>

The composition of a gaseous cleaning composition 3 was examined by performing a simple distillation experiment of the cleaning composition 3 in the same manner as Example 1. The result was 4% by weight of TEG, 86% by weight of META and 10% by weight of NMP. Through this composition, 13.5 g of TEG, 286.1 g of META and 30.8 g of NMP were mixed to prepare a model solution 3, and then, the same solubility test of the adhesion to the dephlegmator as Example 1 was performed except for using the total amount of this model solution 3 and 15 g of the adhesion to the dephlegmator obtained in Synthesis Example 1. As a result, the amount of the insolubles remaining on the wire net was approximately 0 g. This result shows that the adhesion to the dephlegmator was sufficiently dissolved in the model solution 3 and that the vapor-phase cleaning composition 3 through vaporization of the cleaning composition 3 is effective for cleaning the adhesion to the dephlegmator.

### Example 4

### Solubility Test of Liquid Crystalline Polyester

The solubility test of the liquid crystalline polyester was carried out by performing the same experiment as Example 1 except for replacing the cleaning composition 1 with a cleaning composition 4 prepared from 256.3 g of TEG, 46.6 g of META and 30.8 g of N,N-dimethylacetamide (hereinafter referred to as “DMAc”) (dipole moment: 3.72) (the composition of the cleaning composition 4 is shown in Table 1). As a result, the amount of the insolubles remaining on the wire net was approximately 0 g. This result shows that the liquid crystalline polyester or decomposed products thereof were sufficiently dissolved in the cleaning composition 4 and that cleanability of the cleaning composition 4 for the remaining liquid crystalline polyester is favorable.

### <Solubility Test of Adhesion to Dephlegmator>

The composition of a gaseous cleaning composition 4 was examined by performing a simple distillation experiment of the cleaning composition 4 in the same manner as Example 1. The result was 2% by weight of TEG, 70% by weight of META and 28% by weight of DMAc. Through this composition, 6.7 g of TEG, 231.3 g of META and 92.5 g of DMAc were mixed to prepare a model solution 4, and then the same solubility test of the adhesion to the dephlegmator as Example 1 was performed except for using the total amount of this model solution 4 and 15 g of the adhesion to the dephlegmator obtained in Synthesis Example 1. As a result, the amount of the insolubles remaining on the wire net was approximately 0 g. This result shows that the adhesion to the dephlegmator was sufficiently dissolved in the model solution 4 and that the vapor-phase cleaning composition 4 through vaporization of the cleaning composition 4 is effective for cleaning the adhesion to the dephlegmator.

### Example 5

### Solubility Test of Liquid Crystalline Polyester

The solubility test of the liquid crystalline polyester was carried out by performing the same experiment as Example 1 except for replacing the cleaning composition 1 with a cleaning composition 5 prepared from 256.3 g of TEG, 46.6 g of META and 30.8 g of N,N-dimethylformamide (hereinafter referred to as “DMF”) (dipole moment: 3.86) (the composition of the cleaning composition 5 is shown in Table 1). As a result, the amount of the insolubles remaining on the wire net was approximately 0 g. This result shows that the liquid crystalline polyester or decomposed products thereof were sufficiently dissolved in the cleaning composition 5 and that cleanability of the cleaning composition 5 for the remaining liquid crystalline polyester is favorable.

### <Solubility Test of Adhesion to Dephlegmator>

The composition of a gaseous cleaning composition 5 was examined by performing a simple distillation experiment of the cleaning composition 5 in the same manner as Example 1. The result was 3% by weight of TEG, 71% by weight of META and 26% by weight of DMF. Through this composition, 9.9 g of TEG, 234.6 g of META and 85.9 g of DMF were mixed to prepare a model solution 5, and then, the same solubility test of the adhesion to the dephlegmator as Example 1 was performed except for using the total amount of this model solution 5 and 15 g of the adhesion to the dephlegmator obtained in Synthesis Example 1. As a result, the amount of the insolubles remaining on the wire net was approximately 0 g. This result shows that the adhesion to the dephlegmator was sufficiently dissolved in the model solution 5 and that the vapor-phase cleaning composition 5 through vaporization of the cleaning composition 5 is effective for cleaning the adhesion to the dephlegmator.

### Comparative Example 1

### Solubility Test of Liquid Crystalline Polyester

The solubility test of the liquid crystalline polyester was carried out by performing the same experiment as Example 1 except for replacing the cleaning composition 1 with a cleaning composition 6 prepared from 337.2 g of TEG (the composition of the cleaning composition 6 is shown in Table 1). As a result, the amount of the insolubles remaining on the wire net was 3.0 g. This result shows that solubility of the cleaning composition 6 is insufficient for the liquid crystalline polyester or decomposed products thereof, that is, cleanability of the cleaning composition 6 for the remaining liquid crystalline polyester is insufficient.

Thus, the cleaning composition 6 is insufficient in cleanability for the remaining liquid crystalline polyester, therefore, the solubility test of the adhesion to the dephlegmator was not performed for this cleaning composition 6.

### Comparative Example 2

### Solubility Test of Liquid Crystalline Polyester

The solubility test of the liquid crystalline polyester was carried out by performing the same experiment as Example 1 except for replacing the cleaning composition 1 with a cleaning composition 7 prepared from 290.0 g of TEG and 46.6 g of META (the composition of the cleaning composition 7 is shown in Table 1). As a result, the amount of the insolubles remaining on the wire net was approximately 0 g. This result shows that the liquid crystalline polyester or decomposed products thereof were sufficiently dissolved in the cleaning composition 7 and that cleanability of the cleaning composition 7 for the remaining liquid crystalline polyester is favorable.

### <Solubility Test of Adhesion to Dephlegmator>

The composition of a gaseous cleaning composition 7 was examined by performing a simple distillation experiment of the cleaning composition 7 in the same manner as Example 1. The result was 2% by weight of TEG and 98% by weight of META. Through this composition, 6.7 g of TEG and 326.0 g of META were mixed to prepare a model solution 7, and then the same solubility test of the adhesion to the dephlegmator as Example 1 was performed except for using the total amount of this model solution 7 and 15 g of the adhesion to the dephlegmator obtained in Synthesis Example 1. As a result, the amount of the insolubles remaining on the wire net was 1.0 g. This result shows that solubility of the model solution 7 for the adhesion to the dephlegmator is insufficient, that is, the vapor-phase cleaning composition 7 through vaporization of the cleaning composition 7 is not sufficient for cleaning the adhesion to the dephlegmator.

### Comparative Example 3

### Solubility Test of Liquid Crystalline Polyester

The solubility test of the liquid crystalline polyester was carried out by performing the same experiment as Example 1 except for replacing the cleaning composition 1 with a cleaning composition 8 prepared from 290 g of TEG and 42.8 g of NMP (the composition of the cleaning composition 8 is shown in Table 1). As a result, the amount of the insolubles remaining on the wire net was 21.9 g. This result shows that solubility of the cleaning composition 8 is insufficient for the liquid crystalline polyester or decomposed products thereof, that is, cleanability of the cleaning composition 8 for the remaining liquid crystalline polyester is insufficient.

Thus, the cleaning composition 8 is insufficient in cleanability for the remaining liquid crystalline polyester; therefore, the solubility test of the adhesion to the dephlegmator was not performed for this cleaning composition 8.

### Comparative Example 4

### Solubility Test of Liquid Crystalline Polyester

The solubility test of the liquid crystalline polyester was carried out by performing the same experiment as Example 1 except for replacing the cleaning composition 1 with a cleaning composition 9 prepared from 290 g of TEG and 42.8 g of DMAc (the composition of the cleaning composition 9 is shown in Table 1). As a result, the amount of the insolubles remaining on the wire net was 19.8 g. This result shows that solubility of the cleaning composition 9 is insufficient for the liquid crystalline polyester or decomposed products thereof, that is, cleanability of the cleaning composition 9 for the remaining liquid crystalline polyester is insufficient.

Thus, the cleaning composition 9 is insufficient in cleanability for the remaining liquid crystalline polyester; therefore, the solubility test of the adhesion to the dephlegmator was not performed for this cleaning composition 9.

### Comparative Example 5

### Solubility Test of Liquid Crystalline Polyester

The solubility test of the liquid crystalline polyester was carried out by performing the same experiment as Example 1 except for replacing the cleaning composition 1 with a cleaning composition 10 prepared from 290 g of TEG and 42.8 g of DMF (the composition of the cleaning composition 10 is shown in Table 1). As a result, the amount of the insolubles remaining on the wire net was 24.2 g. This result shows that solubility of the cleaning composition 10 is insufficient for the liquid crystalline polyester or decomposed products thereof, that is, cleanability of the cleaning composition 10 for the remaining liquid crystalline polyester is insufficient.

Thus, the cleaning composition 10 is insufficient in cleanability for the remaining liquid crystalline polyester; therefore, the solubility test of the adhesion to the dephlegmator was not performed for this cleaning composition 10.

TABLE 1

| | Solubility test of | | | | | | Solubility test of | | | | | |
|---|---|---|---|---|---|---|---|---|---|---|---|---|
| | liquid crystalline polyester | | | | | | adhesion to dephlegmator | | | | | |
| | Composition of cleaning | | | | | Amount of | Composition of gaseous | | | | | Amount of |
| | composition (% by weight) | | | | | insolubles | cleaning composition (% by weight) | | | | | insolubles |
| Examples | TEG | META | NMP | DMAc | DMF | (g) | TEG | META | NMP | DMAc | DMF | (g) |
| Example 1 | 76 | 14 | 10 | 0 | 0 | 0 | 3 | 76 | 21 | 0 | 0 | 0 |
| Example 2 | 71 | 14 | 15 | 0 | 0 | 0 | 2 | 72 | 26 | 0 | 0 | 0 |
| Example 3 | 60 | 30 | 10 | 0 | 0 | 0 | 4 | 86 | 10 | 0 | 0 | 0 |
| Example 4 | 76 | 14 | 0 | 10 | 0 | 0 | 2 | 70 | 0 | 28 | 0 | 0 |
| Example 5 | 76 | 14 | 0 | 0 | 10 | 0 | 3 | 71 | 0 | 0 | 26 | 0 |
| Comparative | 100 | 0 | 0 | 0 | 0 | 3.0 | — | — | — | — | — | — |
| Example 1 | | | | | | | | | | | | |
| Comparative | 86 | 14 | 0 | 0 | 0 | 0 | 2 | 98 | 0 | 0 | 0 | 1.0 |
| Example 2 | | | | | | | | | | | | |
| Comparative | 86 | 0 | 14 | 0 | 0 | 21.9 | — | — | — | — | — | — |
| Example 3 | | | | | | | | | | | | |
| Comparative | 86 | 0 | 0 | 14 | 0 | 19.8 | — | — | — | — | — | — |
| Example 4 | | | | | | | | | | | | |
| Comparative | 86 | 0 | 0 | 0 | 14 | 24.2 | — | — | — | — | — | — |
| Example 5 | | | | | | | | | | | | |

### Examples 6 to 10

A para-hydroxybenzoic acid (995 g (7.2 mol)), a 4,4′-dihydroxybiphenyl (447 g (2.4 mol)), a terephthalic acid (299 g (1.8 mol)), an isophthalic acid (99.6 g (0.60 mol)) and an acetic anhydride (1348 g (13.2 mol)) were charged into a reaction vessel (condensation polymerization tank) provided with a stirrer, a torquemeter, a nitrogen gas introduction pipe, a thermometer and a reflux cooler (dephlegmator), and these components were stirred. Next, 0.18 g of 1-methylimidazole was added to the mixture after being stirred, and the inside of the reaction vessel was sufficiently replaced with nitrogen gas, thereafter heated to a temperature of 150° C. over 15 minutes under nitrogen gas airflow and refluxed for 1 hour while retaining the temperature. Then, after adding 0.18 g of 1-methylimidazole, the inside thereof was heated to a temperature of 305° C. over 2 hours and 50 minutes while distilling off by-produced distillate acetic acid and unreacted acetic anhydride. The time point when the rise of torque was observed was regarded as the completion of the reaction, and the produced liquid crystalline polyester was discharged out of the condensation polymerization tank.

The condensation polymerization tank after discharging the liquid crystalline polyester was thus prepared to put each of the cleaning compositions used in Examples 1 to 5 (the cleaning compositions 1 to 5) so as to occupy 70% by volume of the internal volume thereof. Then, this cleaning composition was heated up until vaporized and refluxed, and kept warm at the temperature for approximately 2 hours. The cleaning composition was cooled and discharged out to thereafter put water up to approximately 70% by volume of the internal volume of the condensation polymerization tank, and this water was also vaporized and refluxed for approximately 2 hours, and further properly cooled and discharged out. In addition, the inside of the condensation polymerization tank was dried. Thus, with regard to the cleaned condensation polymerization tank, the remaining liquid crystalline polyester in the inside thereof (an inner wall of the condensation polymerization tank) was also removed sufficiently and the adhesion to the dephlegmator was also removed sufficiently.

What is claimed is:

1. A cleaning composition used for cleaning a device for producing a liquid crystalline polyester, the composition comprising the following component (A), component (B) and component (C):
(A) glycols;
(B) amines; and
(C) a compound selected from the group consisting of cyclic esters, amides and sulfoxides,
wherein the content of the component (B) is 5 to 40% by weight and the content of the component (C) is 5 to 30% by weight, both being with respect to the total weight of the cleaning composition.

2. The cleaning composition according to claim 1, having the boiling point under one atmosphere of not lower than 190° C. and not higher than 240° C.

3. The cleaning composition according to claim 1, wherein the component (A) contains a glycol selected from the group consisting of diethylene glycol, triethylene glycol and tetraethylene glycol.

4. The cleaning composition according to claim 1, wherein the component (B) contains an alkanolamine.

5. A cleaning method for a device for producing a liquid crystalline polyester, the method comprising the steps of:
(1) discharging a liquid crystalline polyester after melt polymerization out of a device for producing the liquid crystalline polyester;
(2) preparing the cleaning composition according to claim 1;
(3) charging the cleaning composition into the production device after the discharging step; and
(4) cleaning the inside of the production device by refluxing the cleaning composition in the production device.
